(19) United States
(12) Patent Application Publication
(10) Pub. No.: US 2007/0244646 A1
(43) Pub. Date: Oct. 18, 2007

(54) METHOD OF FORMATION CHARACTERICATION USING TOOL RESPONSES

(75) Inventors: TIANHUA ZHANG, TIANJIN (CN); IAN DAVID STOWE, BEIJING (CN)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar Land, TX (US)

(21) Appl. No.: 11/279,409

(22) Filed: Apr. 12, 2006

(51) Int. Cl. G06F 19/00

(52) U.S. Cl. 702/6

(57) ABSTRACT

A method of deriving formation characterization comprises receiving measurement data of a substrate area; defining a measurement error distribution; creating multiple parameterized formation models of the subsurface area based on the measurement error distribution and the measurement data; generating multiple tool responses corresponding to the multiple parameterized formation models; considering the generated tool responses corresponding to the multiple parameterized formation models; and deriving the formation characterization based on the result of considering generated tool responses.

### FIELD OF THE INVENTION

The present invention generally relates to the logging of earth formations, and more particularly to methods and apparatus for formation characterization using logging tool responses corresponding to logging measurements.

### BACKGROUND OF THE INVENTION

Wireline tools have been employed to obtain formation measurement. In certain prior art apparatus, induction-logging instruments are susceptible to a variety of environmental effects due to considerable range of investigation. Therefore, to make useful logs, the effects of volume above and below the layer of the interest must be carefully removed. In practice, the Array Induction Imager (AIT) or AIT-family tools are popular in moderate conductive to oil-based-mud logging environment. The AIT tool consists of eight three-coil arrays, six of which are operated simultaneously at two frequencies (AIT-B) or one frequency (AIT-H/M family). The AIT tool can produce wellsite resistivity logs having high resolution and high rejection of borehole rugosity effects. For example, these tools can produce logs that are corrected for the most common environmental effects, e.g. borehole effect, shoulder effect, skin effect, et al.

However, such tools typically need a wellsite post-processing to remove the environmental effects. Due to the high requirement of processing speed at well-sites, as well as the difficulty in quantifying the logging measurement error, the post-processing typically is based on Gaussian error assumption and least-squares inversion, thus the post-processed result is Gaussian mean value. In reality, however, the Gaussian error assumption is not always correct, thus the traditional post-processed result might not be ideal either. For example, if the Gaussian error assumption is violated. AIT 10, 20, 30, 60 and 90-in curves can behave strangely, either formation inhomogeneity or vertical bedding being overlooked, or the separation of the five curves can not be explained from logging environment information. In such situation, the traditional AIT well-site post-processing result cannot provide accurate indication of formation characterization.

### SUMMARY OF THE INVENTION

One aspect of the invention is directed to a method of deriving formation characterization. The method comprises receiving measurement data of a subsurface area; defining a measurement error distribution; creating multiple parameterized formation models of the subsurface area based on the measurement error distribution and the measurement data; generating multiple tool responses corresponding to the multiple parameterized formation models; considering the generated tool responses corresponding to the multiple parameterized formation modes; and deriving the formation characterization based on the result of considering generated tool responses.

Embodiments of the method may further include performing borehole correction of the measurement data on the multiple tool responses and performing vertical processing on the borehole corrected measurement data. The method may further comprise allowing a user to choose the measurement error distribution. The method may further comprise creating multiple parameterized formation models by using Monte Carlo sampling.

Another aspect of the invention is directed to an apparatus for deriving formation characterization. The apparatus comprises means for receiving measurement data of a subsurface area; means for defining a measurement error distribution; means for creating multiple parameterized formation models of the subsurface area based on the measurement error distribution and the measurement data; means for generating multiple tool responses corresponding to the multiple parameterized formation models; means for considering the generated tool responses corresponding to the multiple parameterized formation models; and means for deriving the formation characterization based on the result of considering generated tool responses.

Additional objects and advantages of the invention will become apparent to those skilled in the art upon reference to the detailed description taken in conjunction with the provided figures.

### BRIEF DESCRIPTION OF THE DRAWINGS

The present invention is illustrated by way of example and not intended to be limited by the figures of the accompanying drawings in which like references indicate similar elements and in which:

FIG. 1 is a flowchart showing steps associated with the present method, apparatus, and article of manufacture;

FIG. 2 is a schematic illustration of computer hardware associated with the apparatus and article of manufacture;

FIGS. 3-4 are a related group of diagrams used to describe the experimental result based on the inventive method; and

FIGS. 5-7 are another related group of diagrams used to describe the experimental result based on the inventive method.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

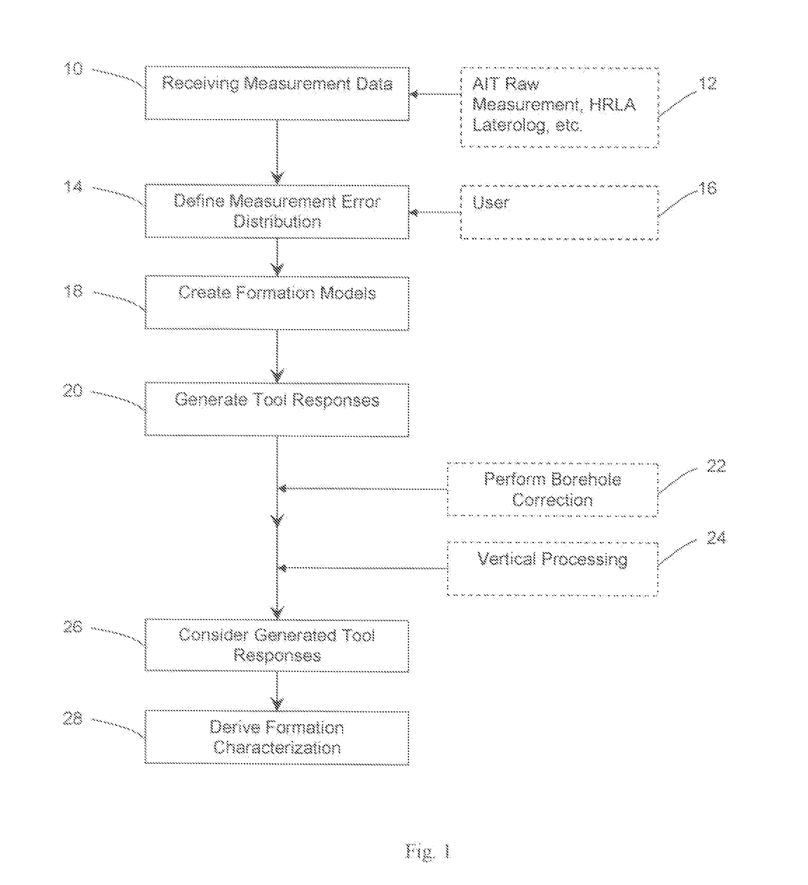

FIG. 1 shows several steps associated with the present method, apparatus and article of manufacture and provides a general overview of the invention. In the Receive Measurement Data Step 10, the Measurement Data of the subsurface area is received. In one embodiment, the received Measurement Data is raw data 12 from arrays of Array Induction Imager (AIT) family tools. The AIT-family tools typically include AIT, PlatformExpress AIT (AIT-H), SlimAccess AIT (SAIT), Xtreme AIT (XAIT), and SlimXtreme AIT (QAIT), etc. In another embodiment, the received Measurement Data is raw data 12 from arrays of High Resolution Laterolog Array (HRLA) tool. Still in another embodiment, the received Measurement Data can be any measurement data (not shown in the drawing) of the subsurface area from a resistivity tool or other tools.

In the Define Measurement Error Distribution Step 14, a user/engineer 16 is allowed here to define the data measurement error distribution. As the induction-logging instruments are susceptible to a variety of environmental effects due to considerable range of investigation, the data measurement error distribution can be very difficult to predict. An expert, with data processing experience, however, can make a reasonable assumption of the data measurement error distribution. A new user can make a wide guess of the data measurement error distribution. In one embodiment, the measurement error distribution is defined based on Gaussian error assumption. The Gaussian error assumption assumes that the error distribution is characterized by a mean value (most possible value in large amount of repeated loggings) and standard deviation σ (the possibility of the measured value drops to 63.2%). The possibility density function is

$$p ( x ) = \frac{1}{\sqrt{2 {πσ}^{2}}} {ⅇ}^{- \frac{{( s - a )}^{2}}{2 {σ}^{2}}} .$$

In another embodiment, the measurement error distribution is defined based on homogeneous error assumption. The homogeneous error assumption assumes that the possibilities of measured values are the same for certainty resistivity range. The possibility density function is p(x)=cons tan t. Still in another embodiment, the measurement error distribution is defined based on Laplacian error assumption. Specifically, the Laplacian distribution is given by its probability density function

$$p ( x ) = \frac{λ}{2} {ⅇ}^{- λ \vert a \vert} .$$

In fact, the user 16 can choose any existing mathematical functions to define the measurement error distribution, or even create his/own functions to define the measurement error distribution. In addition, the user 16 can apply different measurement error distribution definitions and may reach different results of the formation characterization after the following steps, and the user can choose one of the results that appears the most accurate one by comparing the different results of the formation characterization among each other.

In the Create Formation Models Step 18, multiple parameterized formation models of the subsurface area are created based on the measurement error distribution and the measurement data. Typically the parameterized formation models include a plurality of formation and wellbore related parameters, e.g. formation resistivity, invasion diameter, borehole size, mud resistivity, tool stand-off, Young's modulus, Poisson coefficient, shear modulus etc. In one embodiment, a large amount of parameterized formation models are created using Monte Carlo sampling, i.e. after one parameterized formation model is created, the parameterized formation model is accepted with the chance defined by the possibility density function. When large amount of parameterized formation models are created, they map out the user defined possibility density function. In one embodiment, the amount of the parameterized formation models can be 1,000 or even more depending on the user.

In the Generate Tool Responses Step 20, multiple tool responses are generated corresponding to the multiple parameterized formation models created in the Create Formation Models Step 18. In one embodiment, multiple resistivity tool responses are generated by simulating the tools response from a forward modeling engine.

In one embodiment of the invention, the AIT-family log processing includes borehole correction as stated in the Perform Borehole Correction Step 22. The raw data is corrected from all eight arrays for the borehole effect. In one embodiment, borehole corrections for the AIT tools are based on inversion through an iterative forward model to find the borehole parameters that best reproduce the logs from the four shortest arrays—the 6-, 9-, 12-, and 15-in arrays. The borehole forward model is based on a solution to Maxwell's equations in a cylindrical borehole with resistivity Rm surrounded by a homogeneous formation of resistivity Rf.

In one embodiment of the invention, the AIT-family log processing also includes vertical processing as stated in the Vertical Processing Step 24. The borehole corrected data are going through a non-linear procedure to compensate for skin-effect and shoulder effect.

In the Consider Generated Tool Responses Step 26, the generated tool response behavior corresponding to the multiple parameterized formation models is examined. In one embodiment, the generated tool responses are averaged. In another embodiment, the percentage of certain characters of the generated tool response behavior is examined. The user can define the threshold of percentage, e.g. 60% or 80%, for concluding the existence of certain character.

Finally, in the Derive Formation Characterization Step 28, the formation characterization is derived based on the examination results of the generated tool response behavior. In one embodiment, the user 16 can define the percentage threshold for certain formation character. For example, the user may define 80% of the results showing curve separation as indication of a formation bed existence. From the statistics of the Monte Carlo simulated and processed results, if the curve separation is equal or more than 80%, the user can conclude that there exists a formation bed.

Therefore, an embodiment of the inventive method is disclosed. The inventive method allows a user/engineer to define the data measurement error distribution. With the help of this inventive method, AIT response distribution behavior under a large number of formation model and borehole situations can be examined. The inventive method does not reply on the Gaussian error assumption so that when this assumption is violated, the inventive method can give a more reasonable result than traditional well-site post-processing method. In addition, the user can choose different measurement error distribution definitions and may reach different results of the formation characterization. Thus, the user can choose one of the results that appears the most accurate one by comparing the different results of the formation characterization among each other. Further, the user can choose one of the results that appears the most accurate one by comparing the different results of the formation characterization with the results obtained by other means or tools.

There are multiple advantages in applying the inventive method for well-site post-processing. For example, the inventive method can be helpful in formation uncertainty study and answering questions like: whether the inversion is sensitive enough for that parameter; whether there are other possibilities of formation models; whether more information is needed in drawing conclusions, etc. Thus the inventive method can help us to benefit more from traditional AIT measurement interpretation.

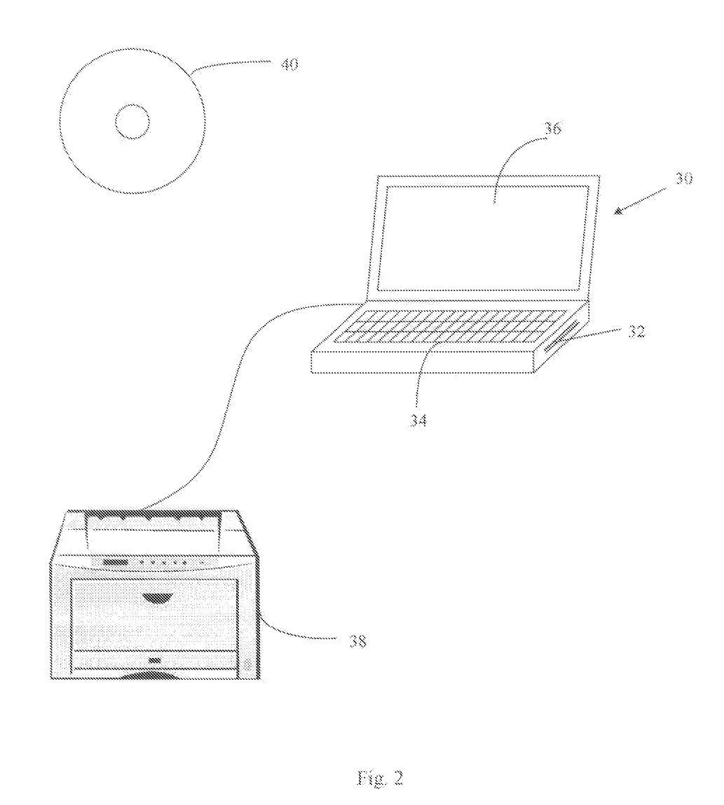

FIG. 2 schematically illustrates computer hardware that may be used to implement the inventive method. Computer 30 has a media reading device, such as a CD-ROM Reader 32, a floppy disk device, or a ZIP drive. The media reading device may also be capable of recording the output of the program the computer 30 is running. A user of the computer 30 may enter commands using a user input device, such as a keyboard 34 or a mouse, may view output of the program code on a visual display device, such as monitor 36, and may make hardcopies of output using an output device, such as printer 38. When properly configured, computer 30 (and its associated peripheral devices) is an apparatus for deriving formation characterization in accordance with the present invention. Computer media, such as a CD-ROM 40, a floppy disk, or a ZIP disk, may have computer readable program code that allows the computer 30 to derive formation characterization in accordance with the inventive method.

We now provide some experimental results of applying the inventive method to derive the formation characterization. A few of case studies are provided, which yields further insights into this invention.

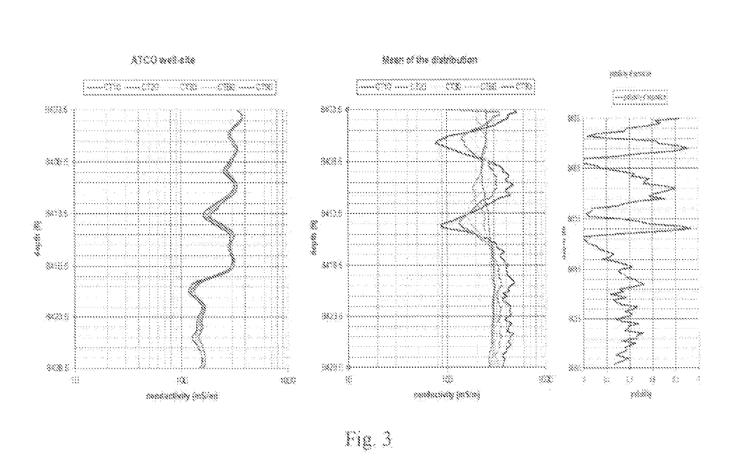

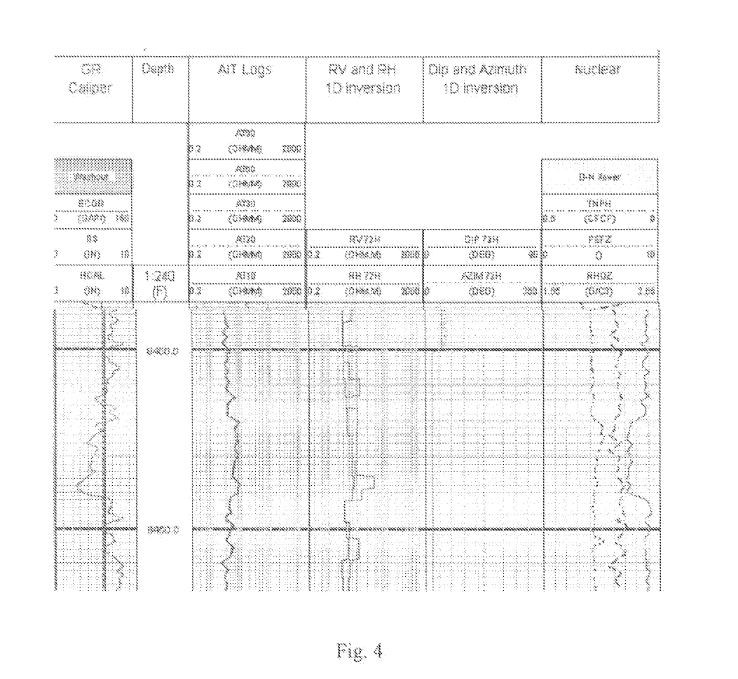

FIG. 3 shows the comparison results between well-site AIT post-processing result based on Gaussian error assumption and based on the inventive method. Specifically, formation anisotropy and vertical thin bed detection of a borehole and formation in La Copital field, Texas, US are examined. On the left, well-site AIT post-processing result, based on traditional Gaussian error assumption, indicates five curves of depth of investigation 10, 20, 30, 60 and 90-in overlap each other (left), showing no invasion, no anisotropy in the depth range 8403-8428 ft. However, the five curves processed with the inventive method show obvious separation and vertical bedding in this depth range (middle). The probability of curve separation among all the samples is shown also on the right panel, indicating at this depth section, around 80% chance there are vertical thin beds with large curve separation. In addition, a fully triaxial induction tool called the Rt Scanner was logged later and shows the formation has weakly anisotropic thin beds in that section, with Rh/Rv=2.0, as shown in FIG. 4 (in which Rh stands for horizontal resistivity and Rv stands for vertical resistivity). In FIG. 4 fourth track, R*72H stands for inversed formation model (Rh and Rv) result from 72-in spacing high frequency and fifth track; DIP and AZIM stands for inversed dip and azimuth results for the specific spacing and frequency. Therefore, well-site AIT post-processing result based on the inventive method provides more accurate results of the formation characterization than that based on Gaussian error assumption.

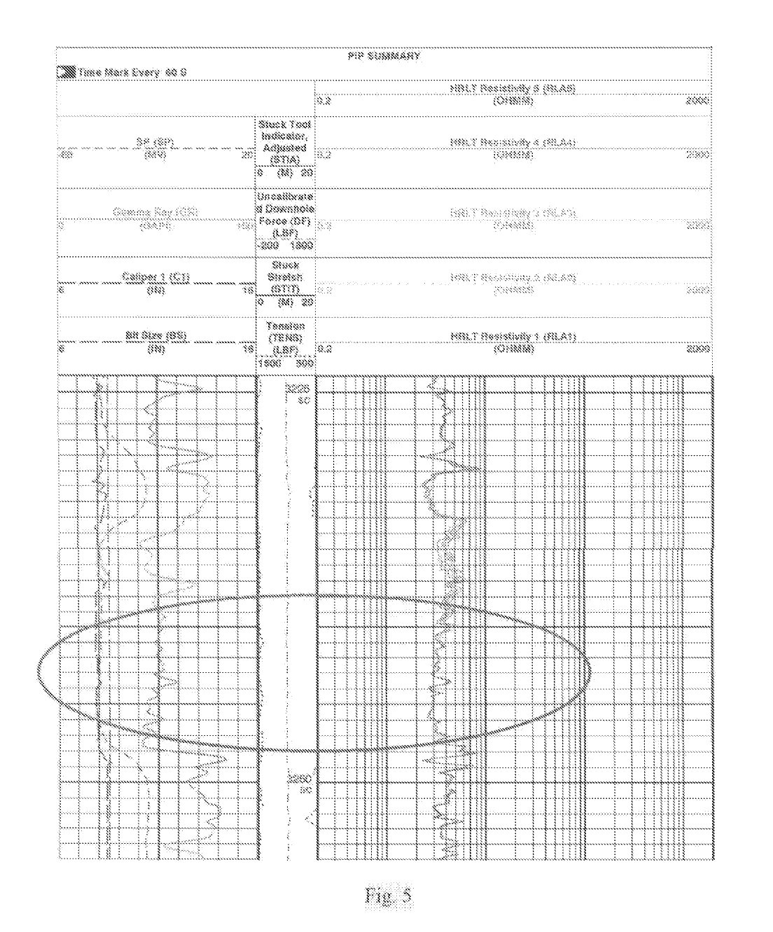

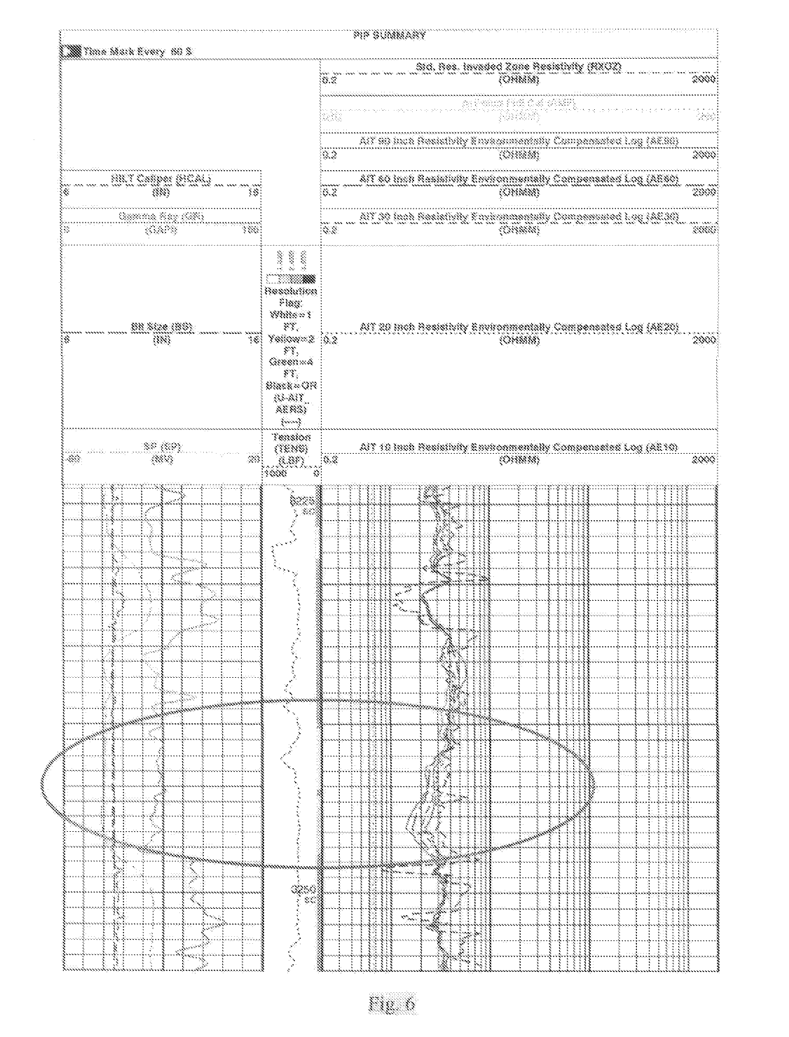

Further example for formation water estimation is illustrated below. Water based mud is used and mud filtrate resistivity is around 0.064 ohm·m. As shown in FIG. 5, in the depth range 3240-3248 m, GR (a nuclear tool that measures formation natural gamma ray radiation) indicates a clean zone. HRLA five curves overlap each other, showing a water zone with more or less constant resistivity Rt of 3 ohm·m. AIT was logged one day after HRLA logging, but the traditional AIT logging shows strange curve separation, which makes it difficult to estimate formation water resistivity, as shown in FIG. 6. Specifically, AIT shows obvious resistive invasion, where the deep curve (AT90) indicates a more conductive and variable formation water with resistivity ranging from 0.5 ohm·m to 2 ohm·m. Since the mud type is very conductive, by the time AIT was logged, conductive invasion can be strong and un-favorable to AIT measurement. If HRLA provides a better estimation in formation water, AIT deep resistivity curve measurement will give an estimation of formation water resistivity only 33% of what has been estimated from HRLA measurements.

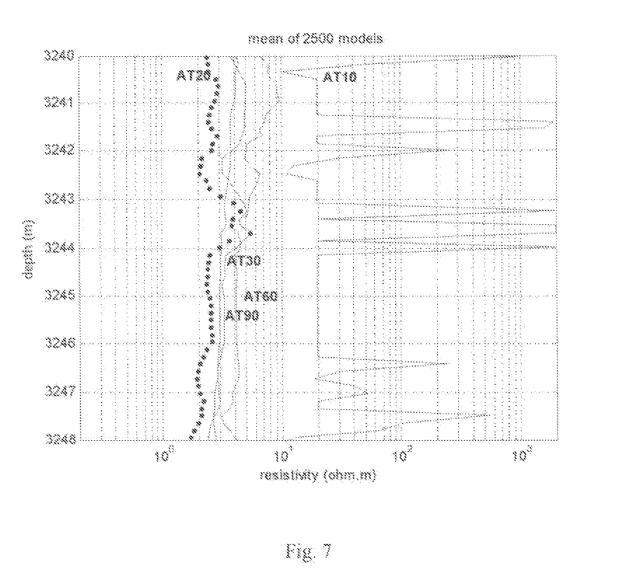

By using the inventive method, the discrepancy can be greatly eliminated. As shown in FIG. 7, by applying the inventive method, the uncertainty method result agrees quite well with HRLA measurement. The AIT deep curve indicates a water zone with resistivity around 3 ohm·m. Also the Monte Carlo large sample results show that quite possibly there was something wrong of the AIT hardware during logging. When there is alternative measurement, like HRLA, it is better using the alternative one.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

We claim:

1. A method of deriving formation characterization comprising:
receiving measurement data of a subsurface area;
defining a measurement error distribution;
creating multiple parameterized formation models of the subsurface area based on said measurement error distribution and said measurement data;
generating multiple tool responses corresponding to said multiple parameterized formation models;
considering the generated tool responses corresponding to said multiple parameterized formation models; and
deriving the formation characterization based on the result of considering generated tool responses.

2. The method of claim 1 further comprising performing borehole correction of said measurement data on said multiple tool responses.

3. The method of claim 2 further comprising performing vertical processing on said borehole corrected measurement data.

4. The method of claim 1, wherein defining said measurement error distribution is based on Gaussian error assumption.

5. The method of claim 1, wherein defining said measurement error distribution is based on homogeneous error assumption.

6. The method of claim 1, wherein defining said measurement error distribution is based on Laplacian error assumption.

7. The method of claim 1, wherein defining said measurement error distribution allows a user to choose said measurement error distribution.

8. The method of claim 1, wherein creating multiple parameterized formation models comprises functions computed using Monte Carlo sampling.

9. The method of claim 1, wherein said multiple parameterized formation models include a large number of formation models.

10. The method of claim 1, wherein generating multiple tool responses includes generating resistivity tool responses.

11. The method of claim 1, wherein generating multiple tool responses includes generating Array Induction Imager (AIT) or AIT-family tool responses.

12. The method of claim 1, wherein generating multiple tool responses includes generating High Resolution Laterolog Array (HRLA) tool responses.

13. The method of claim 1, wherein considering said measurement data includes using probability functions.

14. The method of claim 1, wherein considering said measurement data includes using average functions.

15. The method of claim 1 further comprising comparing the formation characterizations derived from multiple defined measurement error distributions among each other.

16. The method of claim 1, wherein deriving the formation characterization includes defining a percentage threshold for a formation character by a user.

17. An apparatus for deriving formation characterization comprising:
means for receiving measurement data of a subsurface area;
means for defining a measurement error distribution;
means for creating multiple parameterized formation models of the subsurface area based on said measurement error distribution and said measurement data;
means for generating multiple tool responses corresponding to said multiple parameterized formation models;
means for considering the generated tool responses corresponding to said multiple parameterized formation models; and
means for deriving the formation characterization based on the result of considering generated tool responses.

18. The apparatus of claim 17 further comprising means for performing borehole correction of said measurement data on said multiple tool responses.

19. The apparatus of claim 18 further comprising means for performing vertical processing on said borehole corrected measurement data.

20. An article of manufacture, comprising:
a computer usable medium having a computer readable program code means embodied therein for deriving formation characterization, the computer readable program code means in said article of manufacture comprising:
computer-readable program means for receiving measurement data of a subsurface area;
computer-readable program means for defining a measurement error distribution;
computer-readable program means for creating multiple parameterized formation models of the subsurface area based on said measurement error distribution and said measurement data;
computer-readable program means for generating multiple tool responses corresponding to said multiple parameterized formation models;
computer-readable program means for considering the generated tool responses corresponding to said multiple parameterized formation models; and
computer-readable program means for deriving the formation characterization based on the result of considering generated tool responses.
